(19) United States
(12) Patent Application Publication
(10) Pub. No.: US 2025/0076234 A1
(43) Pub. Date: Mar. 6, 2025

(54) Dielectric Spectroscopy Sensor

(71) Applicant: Nippon Telegraph and Telephone Corporation, Tokyo (JP)

(72) Inventors: Masahito Nakamura, Musashino-shi, Tokyo (JP); Takuro Tajima, Musashino-shi, Tokyo (JP); Ayumi Ikeda, Musashino-shi, Tokyo (JP); Michiko Seyama, Musashino-shi, Tokyo (JP)

(21) Appl. No.: 18/721,966

(22) PCT Filed: Jan. 6, 2022
(86) PCT No.: PCT/JP2022/000212

§ 371 Date: Jun. 20, 2024

(51) Int. Cl. G01N 27/02

(52) U.S. Cl. CPC G01N 27/026

(57) ABSTRACT

The present invention includes a transmission line in which a connection line and an impedance converter are connected and a measurement surface which is brought into direct or indirect contact with a measurement target object M and outputs an electromagnetic wave to the measurement target object. The connection line has a first characteristic impedance that is the same as that of a dielectric spectroscopy system. An end on the connection line side of the impedance converter has the first characteristic impedance, and an end on the measurement surface side thereof has a second characteristic impedance different from the first characteristic impedance.

### TECHNICAL FIELD

The present invention relates to a dielectric spectroscopy sensor.

### BACKGROUND ART

A component concentration test such as a blood glucose level requires sampling of blood, which is a heavy burden on a patient. Therefore, a non-invasive component concentration measurement device that does not sample blood has been put into practical use.

As the non-invasive component concentration measurement device, for example, a method using an electromagnetic wave in a microwave to millimeter-wave band has been proposed. The method has an advantage that scattering in a living body is small and energy of one photon is low, as compared with an optical method such as a method using near-infrared light.

As the method using an electromagnetic wave in the microwave to millimeter-wave band, a method using a resonance structure disclosed in Non Patent Literature 1 has been proposed. Non Patent Literature 1 discloses that a device having a high Q value, such as an antenna or a resonator, is brought into contact with a measurement sample to measure a frequency response around a resonance frequency. The resonance frequency is determined based on a complex dielectric constant around the device. Thus, the component concentration can be estimated based on a shift amount of the resonance frequency by predicting in advance a correlation between the shift amount of the resonance frequency and the component concentration.

As another method using an electromagnetic wave in the microwave to millimeter-wave band, a dielectric spectroscopy technique disclosed in Patent Literature 1 has been proposed. The dielectric spectroscopy technique irradiates a skin of a human or animal with an electromagnetic wave, causes the electromagnetic wave to be absorbed according to an interaction between blood components to be measured, for example, glucose molecules and water, and observes an amplitude and phase of the electromagnetic wave. A dielectric relaxation spectrum is calculated based on the amplitude and the phase of a frequency of the observed electromagnetic wave. The dielectric relaxation spectrum is generally expressed as a linear combination of relaxation curves based on the Cole-Cole equation, and the complex dielectric constant is calculated.

The complex dielectric constant is correlated with an amount of blood components such as glucose and cholesterol contained in blood. A calibration model can be built by measuring in advance a correlation between a change in the complex dielectric constant and the component concentration, and the component concentration can be calibrated based on a change in the measured dielectric relaxation spectrum. By using any method, improvement of measurement sensitivity can be expected by selecting a frequency band strongly correlated with a target component. This makes it necessary to measure in advance a change in dielectric constant by broadband dielectric spectroscopy.

Among the dielectric spectroscopy techniques, methods using a coaxial probe (open-ended coaxial probe or open-ended coaxial line), which are disclosed in Non Patent Literatures 2 and 3 and Patent Literature 2, can use a sample such as water which is easily available for calibrating a measuring instrument. Further, the methods can measure a dielectric constant of a measurement sample by bringing a sample to be measured into contact with an end surface of the probe, without requiring special processing of a material. Therefore, the methods are suitable for measuring a sample whose electrical characteristic is to be evaluated while avoiding processing of a living body, fruit, soil, and the like.

### CITATION LIST

### Patent Literature

Patent Literature 1: JP 2013-32933 A
Patent Literature 2: JP 6771372 B2

### Non Patent Literature

Non Patent Literature 1: M. Hofmann, G. Fischer, R. Weigel, and D. Kissinger, “Microwave-Based Noninvasive Concentration Measurements for Biomedical Applications”, IEEE Trans. Microwave Theory and Techniques, Vol. 61, No. 5, pp. 2195-2203, 2013
Non Patent Literature 2: J P. Grant, R N. Clarke, G T. SYymm and N M. Spyrou, “A critical study of the open-ended coaxial line sensor technique for RF and microwave complexpermittivity measurements”, J. Phys. E: Sci. Instrum, Vol. 22, pp. 757-770, 1989
Non Patent Literature 3: T. P. Marsland, and S. Evans “Dielectric measurements with an open-ended coaxial probe”, IEE Proceedings, Vol. 134, No. 4, 1987

### SUMMARY OF INVENTION

### Technical Problem

However, in a case where a dielectric constant is measured by using a transmission line such as a coaxial sensor, the transmission line and a dielectric spectroscopy system to which the transmission line is connected need to have a matched characteristic impedance in order to reduce a loss caused by reflection. For example, in a case where the characteristic impedance of the dielectric spectroscopy system is 50Ω, it is necessary to set an electric wire structure of the transmission line such that the transmission line has the characteristic impedance of 50Ω. Therefore, measurement sensitivity of a reflected wave by the dielectric spectroscopy sensor is limited.

The present invention has been made in view of the above circumstances, and an object thereof is to provide a dielectric spectroscopy sensor capable of improving measurement sensitivity.

### Solution to Problem

A dielectric spectroscopy sensor according to an aspect of the present invention is a dielectric spectroscopy sensor to be connected to a dielectric spectroscopy system having a first characteristic impedance, the dielectric spectroscopy sensor including a transmission line whose first end has the first characteristic impedance and second end has a second characteristic impedance different from the first characteristic impedance, in which the first end is connected to the dielectric spectroscopy system, and the second end serves as a measurement surface for measuring a dielectric constant of a measurement target object.

### Advantageous Effects of Invention

According to the present invention, measurement sensitivity can be improved.

### BRIEF DESCRIPTION OF DRAWINGS

FIG. 1 is a block diagram illustrating a configuration of a dielectric spectroscopy sensor according to a first embodiment of the present invention and a peripheral device thereof.

FIG. 2A is an explanatory diagram illustrating a configuration of a connection line and an impedance converter.

FIG. 2B is a cross-sectional view of the connection line and the impedance converter.

FIG. 3 is a graph showing an amount of change in an S11 parameter or admittance on a complex plane when a dielectric constant changes from “εs” to “εs+Δεs”.

FIG. 4 is a graph showing a relationship between a frequency of a signal applied to a measurement surface and measurement sensitivity.

FIG. 5 is a graph showing another relationship between the frequency of the signal applied to the measurement surface and the measurement sensitivity.

FIG. 6 is a cross-sectional view illustrating another configuration of the impedance converter.

FIG. 7 is a block diagram illustrating a configuration of a dielectric spectroscopy sensor according to second and third embodiments of the present invention and a peripheral device thereof.

FIG. 8A is an explanatory diagram illustrating a configuration of a transmission line according to a second embodiment.

FIG. 8B is a cross-sectional view of the transmission line illustrated in FIG. 8A.

FIG. 9A is a perspective view illustrating a configuration of a measurement surface side of the dielectric spectroscopy sensor according to the third embodiment.

FIG. 9B is a perspective view illustrating a configuration of a line pattern side of the dielectric spectroscopy sensor according to the third embodiment.

FIG. 10 is a graph showing a relationship between a frequency and a characteristic impedance.

FIG. 11 is an explanatory diagram illustrating a metal pattern provided in the dielectric spectroscopy sensor according to the third embodiment.

FIG. 12 is an explanatory diagram illustrating a modification example of the metal pattern provided in the dielectric spectroscopy sensor according to the third embodiment.

### DESCRIPTION OF EMBODIMENTS

Hereinafter, embodiments of the present invention will be described with reference to the drawings.

### Description of First Embodiment

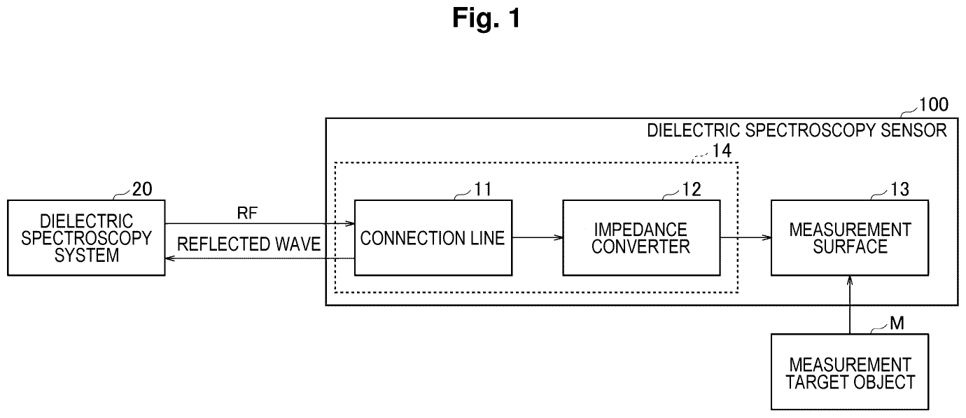

FIG. 1 is a block diagram illustrating a configuration of a dielectric spectroscopy sensor according to a first embodiment of the present invention and a peripheral device thereof. As illustrated in FIG. 1, a dielectric spectroscopy sensor 100 according to the present embodiment is connected to a dielectric spectroscopy system 20 and receives a high-frequency signal (RF) output from the dielectric spectroscopy system 20. The dielectric spectroscopy sensor 100 outputs an electromagnetic wave toward a measurement target object M, receives a reflected wave thereof, and transmits the reflected wave to the dielectric spectroscopy system 20. The measurement target object M is, for example, human skin, animal, fruit, or soil. The dielectric spectroscopy system 20 can use, for example, a general-purpose computer system including a central processing unit (CPU; processor), a memory, a storage (hard disk drive: HDD, solid state drive: SSD), a communication device, an input device, and an output device.

The dielectric spectroscopy sensor 100 includes a connection line 11, an impedance converter 12, and a measurement surface 13. The connection line 11 and the impedance converter 12 form a transmission line 14.

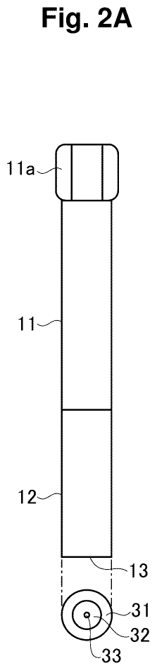

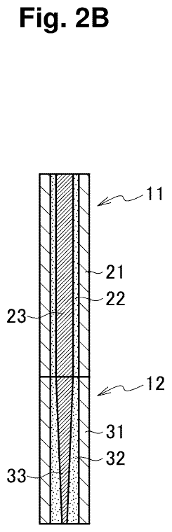

FIG. 2A is an explanatory diagram of the connection line 11 and the impedance converter 12, and FIG. 2B is a cross-sectional view of the connection line 11 and the impedance converter 12 taken along the longitudinal direction.

As illustrated in FIG. 2A, the connection line 11 and the impedance converter 12 have an elongated coaxial cable structure, and one end thereof serves as the measurement surface 13, whereas the other end thereof is connected to a high-frequency connector 11a.

The high-frequency connector 11a is a connector for electrically connecting to the dielectric spectroscopy system 20 of FIG. 1. Examples of the high-frequency connector 11a include an SMA connector, a K connector, a 2.4 mm connector, a V connector, an SMP connector, an SMPM connector, and a G3PO connector.

The measurement surface 13 is brought into direct or indirect contact with or is brought close to the measurement target object M such as human skin at the time of measuring a component. The component to be measured is, for example, a blood glucose level of a subject.

As illustrated in FIGS. 2A and 2B, the connection line 11 includes an inner conductor 23, a dielectric 22 concentrically formed around the inner conductor 23, and an outer conductor 21 concentrically formed around the dielectric 22. The inner conductor 23 has a constant diameter. That is, the connection line 11 is formed to have a coaxial cable structure including the inner conductor 23 and the outer conductor 21 having the constant diameter.

The impedance converter 12 includes an inner conductor 33, a dielectric 32 concentrically formed around the inner conductor 33, and an outer conductor 31 concentrically formed around the dielectric 32. That is, the impedance converter 12 is formed to have a coaxial cable structure. The inner conductor 33 has a gradually changing diameter. Specifically, the inner conductor 33 has the same diameter as the inner conductor 23 at a connection end to the connection line 11 and is formed such that the diameter gradually decreases toward the measurement surface 13 that is a lower end surface.

In the connection line 11, the diameter of the inner conductor 23 is set so as to match with a characteristic impedance (first characteristic impedance) at a connection end of the dielectric spectroscopy system 20 in FIG. 1. That is, an end (first end) on the dielectric spectroscopy system 20 side of the transmission line 14 is set to have the first characteristic impedance. Therefore, when the high-frequency connector 11a is connected to the dielectric spectroscopy system 20, a characteristic impedance is matched between the dielectric spectroscopy system 20 and the dielectric spectroscopy sensor 100. The connection line 11 may be a coaxial cable such as a semi-rigid or soft rigid cable.

A characteristic impedance of the impedance converter 12 at a connection end to the connection line 11 is set to the first characteristic impedance that is the same as that of the connection line 11. In the measurement surface 13, which is the lower end surface of the impedance converter 12, the diameter of the inner conductor 33 is smaller than the diameter of the inner conductor 23 of the connection line 11, and thus the characteristic impedance is changed. That is, the impedance converter 12 can change the first characteristic impedance to a second characteristic impedance different from the first characteristic impedance by changing the diameter of the inner conductor 33.

That is, the transmission line 14 is formed by connecting the connection line 11 and the impedance converter 12, and the connection line 11 has the first characteristic impedance as the characteristic impedance, has one end as the first end, and has the other end connected to the impedance converter 12. The impedance converter 12 has one end having the first characteristic impedance and connected to the other end of the connection line 11 and has the other end having the second characteristic impedance different from the first characteristic impedance and serving as a second end.

The impedance converter 12 has a coaxial cable structure including the inner conductor 33 and the outer conductor 31 arranged outside the inner conductor 33 via the dielectric 32, and the one end of the impedance converter 12 has the first characteristic impedance, and the second end has the second characteristic impedance by monotonically increasing or monotonically decreasing a cross-sectional area of the inner conductor 33 from the end connected to the connection line 11 toward the second end. Hereinafter, the conversion of the characteristic impedance will be described in detail.

When the characteristic impedance of the coaxial cable forming the impedance converter 12 is “Zcoax”, Zcoax can be shown by the following Equation (1).

$$[ Math . 1 ]$$

$${Z}_{coax} = \frac{138.1}{\sqrt{{ε}_{c}}} log \frac{D}{d} \qquad Equation ( 1 )$$

In Equation (1), “cc” denotes a dielectric constant of the dielectric 32, “D” denotes an inner diameter of the outer conductor 31, and “d” denotes an outer diameter of the inner conductor 33. The sign “log” denotes a natural logarithm. The inner diameter D of the outer conductor 31 of the impedance converter 12 and the dielectric constant Cc of the dielectric 32 are constant, and thus a characteristic impedance on the measurement surface 13 can be set to a desired characteristic impedance by changing the inner diameter d of the inner conductor 33.

A calculation equation for the characteristic impedance of the transmission line other than the above may be used, or conversion efficiency of the characteristic impedance may be calculated by using an electromagnetic field simulator or the like.

Next, there will be described a procedure of setting the characteristic impedance of the measurement surface 13 to an optimum numerical value in order to enhance sensitivity of the dielectric spectroscopy sensor 100.

First, a dielectric constant εs of the measurement target object M is measured by using the dielectric spectroscopy sensor 100 according to the embodiment. When an admittance of the measurement surface 13 of the dielectric spectroscopy sensor 100 is denoted by Y(εs), Y(εs) can be shown by the following Equation (2).

$$[ Math . 2 ]$$

$$Y ( {ε}_{s} ) = \frac{{jk}_{0} {ε}_{s}}{\sqrt{{ε}_{c}} log ( \frac{b}{a} )} {\int }_{0}^{∞} \frac{{[ {J}_{0} ( ζ a ) - {J}_{0} ( ζ b ) ]}^{2}}{γ ( {ε}_{s} ) ζ} d ζ \qquad Equation ( 2 )$$

In Equation (2), “εc” denotes the dielectric constant of the dielectric 32, “k0” denotes a wave number in a measurement frequency, “εs” denotes the dielectric constant of the measurement target object M, “γ(εs)” denotes a propagation constant inside the measurement target object M, “J0(x)” denotes a zero order Bessel function, “a” denotes a radius of the inner conductor 33, “b” denotes a radius of the outer conductor 31, and “ζ” denotes a weighting factor of the Hankel transform.

A reflection coefficient S11 (hereinafter, also referred to as an S11 parameter) can be measured by outputting a high-frequency signal (RF) from the dielectric spectroscopy system 20 of FIG. 1 and receiving a reflected wave thereof. The dielectric spectroscopy system 20 includes an oscillator, receiver, and arithmetic unit (all not illustrated) for a high-frequency signal.

The dielectric spectroscopy system 20 can be, for example, a high-frequency measuring instrument, such as a vector network analyzer or a spectrum analyzer, or a reflection measurement system using a microwave IC. In the dielectric spectroscopy system 20, for example, the characteristic impedance at a connection portion is set to 50Ω. The S11 parameter measured by the dielectric spectroscopy system 20 is shown by the following Equation (3).

$$[ Math . 3 ]$$

$${S}_{11} ( {ε}_{s} ) = \frac{1 - Y ( {ε}_{s} )}{1 + Y ( {ε}_{s} )} \qquad Equation ( 3 )$$

The sensitivity of the dielectric spectroscopy sensor 100 is determined based on a change in the S11 parameter with respect to a change in the dielectric constant εs of the measurement target object M. That is, the sensitivity is determined by the following Equation (4).

$$[ Math . 4 ]$$

$$Sensitivity = \frac{d}{d {ε}_{s}} {S}_{11} ( {ε}_{s} ) \qquad Equation ( 4 )$$

As understood from the above Equation (3), the S11 parameter of the dielectric spectroscopy sensor 100 is determined based on an amount of change in the admittance, and thus the following Equation (5) may be used instead of Equation (4).

$$[ Math . 5 ]$$

$$Sensitivity = \frac{d}{d {ε}_{s}} Y ( {ε}_{s} ) \qquad Equation ( 5 )$$

The symbol “S11(εs)” is included on the right side of Equation (4), and “Y(εs)” is included on the right side of Equation (5). Both the symbols “S11 (εs)” and “Y(εs)” are complex numbers.

Both Equations (4) and (5) include the above Equation (2). Further, a logarithmic function “log(b/a)” and the Bessel function “J_0(ζa) and J_0(ζb)” are included on the right side of Equation (2). Therefore, the sensitivity of the dielectric spectroscopy sensor 100 can be set to be high by appropriately changing numerical values of the radius “a” of the inner conductor 33 and the radius “b” of the outer conductor 31 included in the impedance converter 12.

For example, in a case where the impedance converter 12 is not used, the characteristic impedance of the dielectric spectroscopy sensor 100 needs to match with the first characteristic impedance and thus is limited to, for example, 50Ω. However, by using the impedance converter 12, it is possible to change the characteristic impedance of the dielectric spectroscopy sensor 100 to the second characteristic impedance different from the first characteristic impedance. This makes it possible to design the highly sensitive dielectric spectroscopy sensor 100.

In a case where the measurement target object M is a low-loss material such as a resin or a high-frequency substrate, the dielectric constant εs is dominant in a change in a real part over an imaginary part. Therefore, the sensitivity may be evaluated by using any one of the amplitude and the phase when the above Equation (4) is shown in phasor notation or any one of the real part and the imaginary part of Equation (5).

In a case where the measurement target object M has frequency dispersion such as water, an organic solvent, or other liquids containing biological components, and a dielectric loss cannot be ignored, the dielectric constant εs is a complex number, and frequency dependences of amounts of change in the real part and the imaginary part are different from each other.

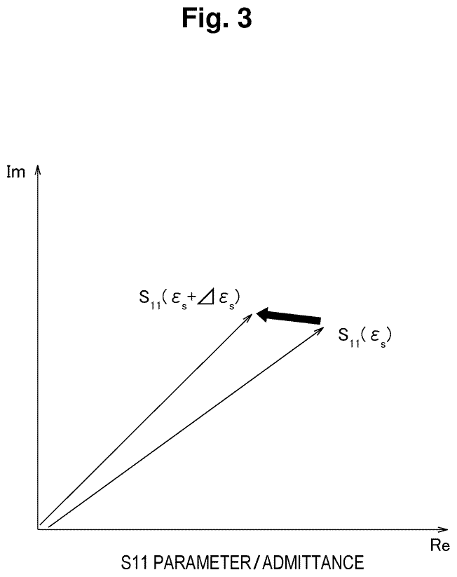

At this time, as shown in FIG. 3, the S11 parameter when the dielectric constant changes from “εs” to “εs+Δεs” or the amount of change in the admittance on the complex plane can be regarded as the sensitivity. That is, the above Equations (4) and (5) can be rewritten as the following Equations (6) and (7), respectively.

$$[ Math . 6 ]$$

$$Sensitivity = \sqrt{{real ( \frac{d}{d {ε}_{s}} {S}_{11} ( {ε}_{s} ) )}^{2} + {imag ( \frac{d}{d {ε}_{s}} {S}_{11} ( {ε}_{s} ) )}^{2}} \qquad Equation ( 6 )$$

$$[ Math . 7 ]$$

$$Sensitivity = \sqrt{{real ( \frac{d}{d {ε}_{s}} Y ( {ε}_{s} ) )}^{2} + {imag ( \frac{d}{d {ε}_{s}} Y ( {ε}_{s} ) )}^{2}} \qquad Equation ( 7 )$$

The characteristic impedance of the dielectric spectroscopy sensor 100 only needs to be designed by using the above Equations (6) and (7) so as to achieve a condition that maximizes the sensitivity in a desired frequency, for example, in a “3 to 10 GHz” band in a case where the measurement target is a molecule of glucose.

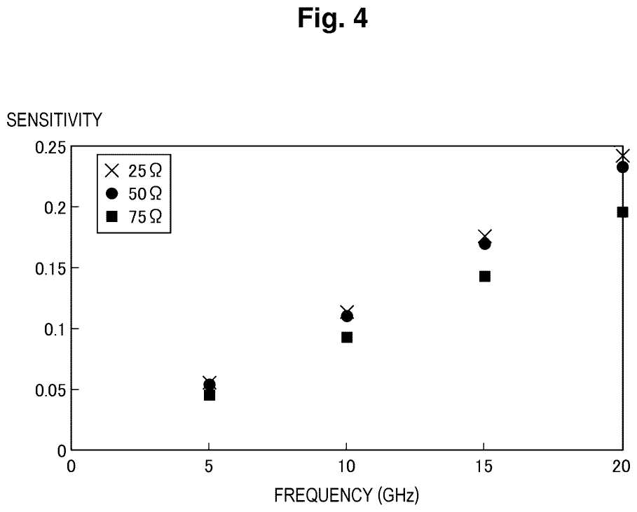

FIG. 4 is a graph showing a relationship between a frequency of a voltage applied between the inner conductor 33 and the outer conductor 31 on the measurement surface 13 and the sensitivity. The inner diameter of the outer conductor 31 is 3 mm, the dielectric constant of the dielectric 32 is 3.3, and the dielectric constant εs of the measurement target object M is a dielectric constant of air.

As shown in FIG. 4, the sensitivity decreases in a case where the characteristic impedance is changed from 50Ω to 75Ω by changing the diameter of the inner conductor 33. It is found that the sensitivity increases in a case where the characteristic impedance is changed from 50Ω to 25Ω. That is, the measurement sensitivity of the dielectric spectroscopy sensor 100 can be enhanced by the impedance converter 12 converting the characteristic impedance from 50Ω (first characteristic impedance) to 25Ω (second characteristic impedance).

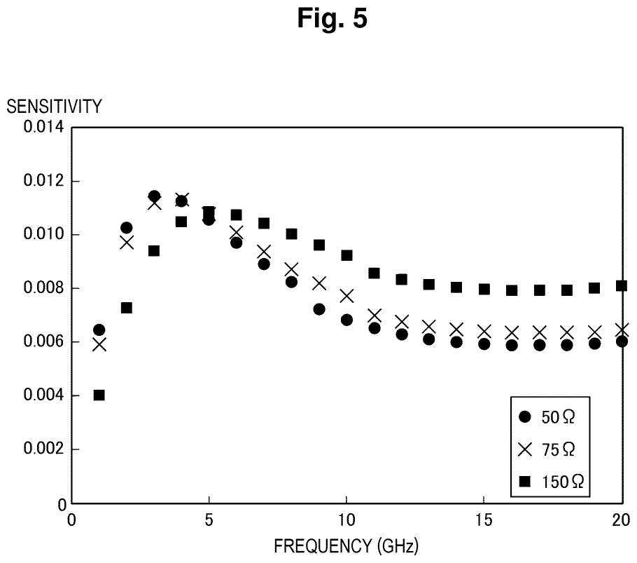

FIG. 5 is a graph showing another relationship between the frequency of the voltage applied between the inner conductor 33 and the outer conductor 31 on the measurement surface 13 and the sensitivity. The inner diameter of the outer conductor 31 is 3 mm, the dielectric constant of the dielectric 32 is 2.1, and the dielectric constant εs of the measurement target object M is a dielectric constant of pure water.

As shown in FIG. 5, the sensitivity has a peak value in a GHz band, and, for example, a peak frequency when the characteristic impedance is 75Ω is different from a peak frequency when the characteristic impedance is 150 Ω.

Therefore, the peak frequency can be shifted by changing the characteristic impedance. This makes it possible to design the dielectric spectroscopy sensor so as to have high sensitivity in a frequency band in which an amount of change in a desired component is significant, for example, in a 5 to 10 GHz band.

Because a characteristic impedance of an end surface of a conventional coaxial sensor is, for example, 50Ω, it is possible to measure the dielectric constant with higher accuracy by using the dielectric spectroscopy sensor 100 of the present embodiment than by using the conventional sensor. In particular, the sensitivity can be more remarkably improved for a material having a dielectric loss, such as a biological sample.

### Modification Example of Impedance Converter

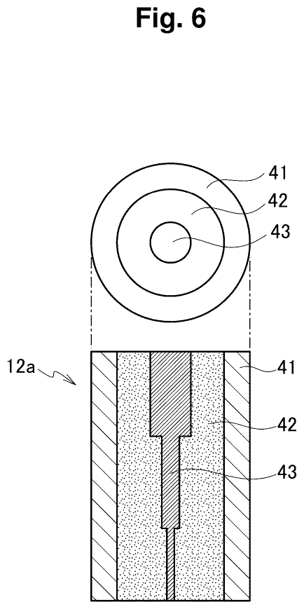

Next, a modification example of the impedance converter will be described. FIG. 6 is an explanatory diagram illustrating the modification example of the impedance converter. As illustrated in FIG. 6, an inner conductor 43, a dielectric 42, and an outer conductor 41 are coaxially formed in an impedance converter 12a according to the modification example as in the first embodiment described above.

The inner conductor 43 has a diameter that changes stepwise (three stages in FIG. 6). That is, the diameter of the inner conductor 33 is continuously changed in the first embodiment, whereas, in the impedance converter 12a according to the modification example, the diameter of the inner conductor 43 is changed stepwise. Also in such a configuration, the first end can have the first characteristic impedance, and the second end can have the second characteristic impedance as in the first embodiment described above.

That is, the impedance converter 12a has a coaxial cable structure including the inner conductor 43 and the outer conductor 41 arranged outside the inner conductor 43 via the dielectric 42, and one end of the impedance converter 12 has the first characteristic impedance, and the second end has the second characteristic impedance by changing stepwise a cross-sectional area of the inner conductor 43 from the end connected to the connection line 11 toward the second end.

As described above, the dielectric spectroscopy sensor 100 according to the present embodiment is the dielectric spectroscopy sensor 100 to be connected to the dielectric spectroscopy system 20 having the first characteristic impedance, the dielectric spectroscopy sensor including the transmission line 14 whose first end has the first characteristic impedance and second end has the second characteristic impedance different from the first characteristic impedance, in which the first end is connected to the dielectric spectroscopy system 20, and the second end serves as the measurement surface 13 for measuring a dielectric constant of a measurement target object.

In the dielectric spectroscopy sensor 100 according to the present embodiment, the one end of the impedance converter 12 has the first characteristic impedance, and the other end thereof has the second characteristic impedance. Thus, the characteristic impedance can be matched between the impedance converter 12 and the connection line 11.

The characteristic impedance can be matched at a connection portion between the connection line 11 and the dielectric spectroscopy system 20. This makes it possible to reduce a reflection loss at a connection portion between the transmission line 14 and the dielectric spectroscopy system 20. Further, the characteristic impedance on the measurement surface 13 can be arbitrarily set, thereby improving the sensitivity of the dielectric spectroscopy sensor 100.

In the dielectric spectroscopy sensor 100 according to the first embodiment, accuracy of a calibration curve at the time of quantitative measurement of a desired component can be enhanced by improving the sensitivity of the dielectric spectroscopy sensor 100. Further, concentration of a detection limit can be reduced.

In the dielectric spectroscopy sensor 100 according to the first embodiment, the transmission line 14 is formed by connecting the impedance converter 12 to the connection line 11. This makes it possible to retrofit the impedance converter 12 to the existing connection line 11, thereby improving versatility.

### Description of Second Embodiment

Next, a second embodiment of the present invention will be described. The above first embodiment shows an example where the transmission line 14 includes the connection line 11 and the impedance converter 12. The second embodiment is different from the above first embodiment in that the transmission line 14 has a function of converting an impedance.

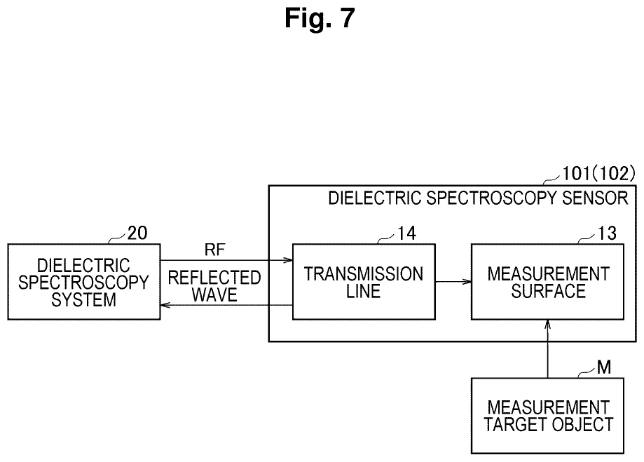

FIG. 7 is a block diagram illustrating a configuration of a dielectric spectroscopy sensor according to the second embodiment of the present invention and a peripheral device thereof. As illustrated in FIG. 7, a dielectric spectroscopy sensor 101 according to the second embodiment is connected to the dielectric spectroscopy system 20 and receives a high-frequency signal (RF) output from the dielectric spectroscopy system 20, as in the first embodiment. The dielectric spectroscopy sensor 101 outputs an electromagnetic wave toward the measurement target object M, receives a reflected wave thereof, and transmits the reflected wave to the dielectric spectroscopy system 20.

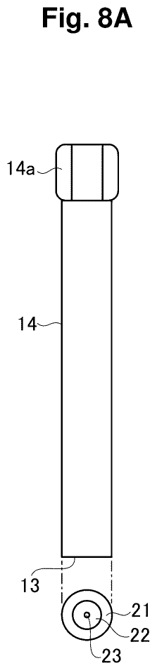

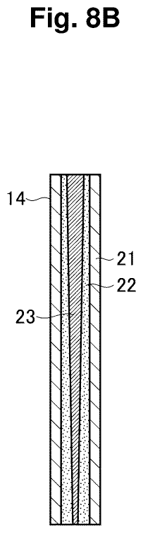

The dielectric spectroscopy sensor 101 includes the transmission line 14 and the measurement surface 13. FIG. 8A is an explanatory diagram of the transmission line 14, and FIG. 8B is a cross-sectional view of the transmission line 14 taken along the longitudinal direction.

As illustrated in FIG. 8A, the transmission line 14 has an elongated coaxial cable structure, and one end thereof serves as the measurement surface 13, whereas the other end thereof is connected to a high-frequency connector 14a. The high-frequency connector 14a is a connector for connecting to the dielectric spectroscopy system 20. The measurement surface 13 is brought into direct or indirect contact with or is brought close to the measurement target object M such as human skin at the time of measuring a component.

The transmission line 14 includes the inner conductor 23, the dielectric 22 concentrically formed around the inner conductor 23, and the outer conductor 21 concentrically formed around the dielectric 22. That is, the transmission line 14 is formed to have a coaxial cable structure. The inner conductor 23 has a gradually changing diameter. Specifically, the diameter gradually decreases from a connection end (first end) to the high-frequency connector 14a toward the measurement surface 13 (second end).

As illustrated in FIG. 8B, the connection end (first end) on the high-frequency connector 14a side of the transmission line 14 has the first characteristic impedance. That is, the diameter of the inner conductor 23 is set such that the end on the high-frequency connector 14a side of the transmission line 14 matches with the characteristic impedance at the connection end of the dielectric spectroscopy system 20. When the high-frequency connector 14a is connected to the dielectric spectroscopy system 20, the characteristic impedance is matched between the dielectric spectroscopy system 20 and the dielectric spectroscopy sensor 100.

In the measurement surface 13, which is the lower end surface of the transmission line 14, the diameter of the inner conductor 23 is smaller than the diameter of the inner conductor 23 on the high-frequency connector 14a side of the transmission line 14, and thus the characteristic impedance is changed. That is, the transmission line 14 can change the first characteristic impedance to the second characteristic impedance different from the first characteristic impedance by changing the diameter of the inner conductor 23.

Also in the second embodiment of FIGS. 8A and 8B as well as in the above first embodiment, it is possible to set the characteristic impedance in the measurement surface 13 to the second characteristic impedance different from the first characteristic impedance by adjusting the diameter of the inner conductor 23 of the transmission line 14, thereby enhancing the sensitivity of the dielectric spectroscopy sensor 101.

### Description of Third Embodiment

Next, a third embodiment of the present invention will be described. In the third embodiment, a printed wiring board is used as the transmission line 14 of FIG. 7.

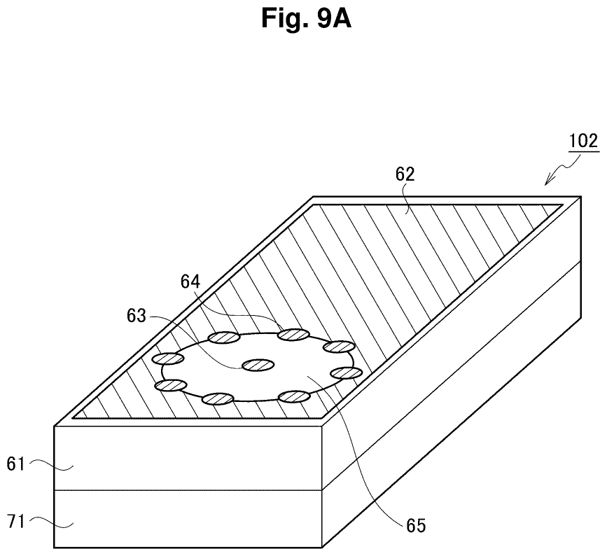

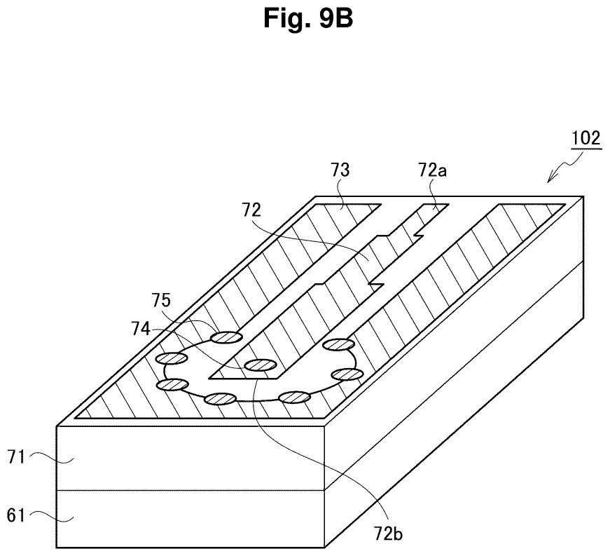

FIGS. 9A and 9B are perspective views illustrating a configuration of a dielectric spectroscopy sensor 102 according to the third embodiment. The dielectric spectroscopy sensor 102 of FIGS. 9A and 9B has a structure in which a first substrate 61 and a second substrate 71 that are dielectric substrates are stacked.

FIG. 9A is a perspective view when the first substrate 61 having a surface to be brought into contact with the measurement target object M faces upward. FIG. 9B is a perspective view when the second substrate 71 having a line surface on which a line is formed faces upward. That is, when the dielectric spectroscopy sensor 102 in FIG. 9A is turned over, the dielectric spectroscopy sensor 102 can be seen as in FIG. 9B.

As illustrated in FIG. 9A, a metal pattern 62 having a circular opening 65 is provided on a surface of the first substrate 61. The opening 65 is a region where no metal pattern exists and is, for example, a dielectric surface.

A via 63 penetrating the first substrate 61 is provided at the center of the opening 65. A plurality of (eight in FIG. 9A) vias 64 conducted to the metal pattern 62 is provided along a circumference of the opening 65. That is, the dielectric spectroscopy sensor 102 according to the third embodiment forms a quasi-coaxial structure by providing the plurality of vias 64 in a circular shape around the via 63. The vias 63 and 64 are filled with a conductor. The via 63 and the plurality of vias 64 formed therearound serve as the measurement surface 13 (see FIG. 7) which is brought into contact with the measurement target object M.

As illustrated in FIG. 9B, metal patterns 72 and 73 forming coplanar lines are provided on a surface of the second substrate 71. The metal pattern 72 (first conductor) serves as a signal line of the coplanar lines, and the metal pattern 73 serves as a ground line (second conductor) insulated from the metal pattern 72.

That is, the transmission line 14 includes the substrates 61 and 71, the first conductor (metal pattern 72) formed from one end to the other end on a surface of the substrate, and the second conductor (metal pattern 73) insulated from the first conductor, in which the characteristic impedance at one end of the first conductor is the first characteristic impedance, and the characteristic impedance on the other end thereof is the second characteristic impedance.

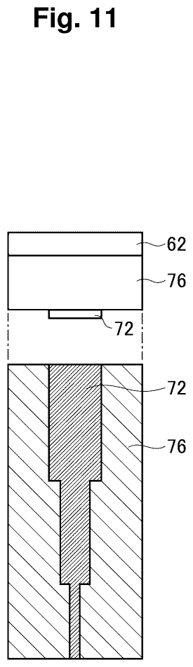

FIG. 11 is an explanatory diagram schematically illustrating a configuration of the metal pattern 72. In FIG. 11, the metal pattern 72 serving as the signal line is formed on a front surface of a dielectric 76, and the metal pattern 62 connected to the metal pattern 73 serving as the ground line is formed on a back surface of the dielectric 76. The metal patterns 72 and 73 of FIG. 9B correspond to the transmission line 14 of FIG. 8. The metal patterns can be not only the coplanar lines, but also, for example, transmission lines on a printed circuit board or semiconductor substrate, such as a microstrip line, a coplanar line, or a coplanar strip.

In the second substrate 71 of FIG. 9B, a via 74 and a plurality of vias 75 are provided corresponding to positions of the vias 63 and 64 of FIG. 9A. The via 74 is conducted to the via 63 and the metal pattern 72. The vias 75 are conducted to the vias 64 and the metal pattern 73.

As illustrated in FIG. 9B, a line width of the metal pattern 72 is configured such that a pattern width increases stepwise from one end 72a toward the other end 72b. The end 72a of the metal pattern 72 serves as the first end connected to the dielectric spectroscopy system 20 of FIG. 8, and the end 72b serves as the second end connected to the measurement surface 13.

The characteristic impedance at the end 72a (first end) of the metal pattern 72 is set to match with the first characteristic impedance of the dielectric spectroscopy system 20. Therefore, in a case where the end 72a of the metal pattern 72 is connected to the dielectric spectroscopy system 20, the characteristic impedance is matched.

Because the line width of the metal pattern 72 changes from the end 72a toward the end 72b, the characteristic impedance at the second end is the second characteristic impedance different from the first characteristic impedance. That is, it is possible to set the second characteristic impedance on the measurement surface 13 of the dielectric spectroscopy sensor 102 to a desired numerical value by adjusting the line width of the metal pattern 72.

The one end of the first conductor has the first characteristic impedance, and the other end of the first conductor has the second characteristic impedance by monotonically increasing or monotonically decreasing the line width of the first conductor from the one end to the other end on the surface of the substrate.

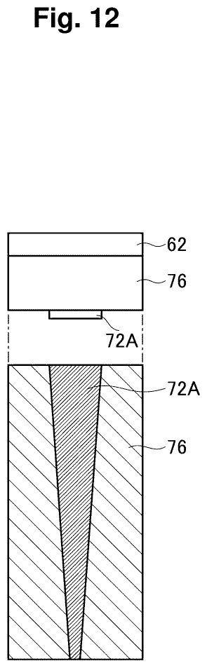

FIGS. 9A and 9B illustrate an example where the line width of the metal pattern 72 changes stepwise, but, as illustrated in FIG. 12, a metal pattern 72A whose line width changes in a tapered shape may be used.

In the example of FIG. 12, the one end of the first conductor (metal pattern 72A) has the first characteristic impedance, and the other end of the first conductor has the second characteristic impedance by changing the line width of the first conductor in the tapered shape from the one end to the other end of the substrate.

When the characteristic impedance of the dielectric spectroscopy sensor 102 having the substrate structure of FIGS. 9A and 9B is denoted by ZMSL, the characteristic impedance ZMSL can be shown by the following Equation (8).

$$[ Math . 8 ]$$

$${Z}_{MSL} = \frac{1}{\sqrt{{ε}_{sub}}} \cdot 60 log [ \frac{8 h}{W} - 0.358 + \frac{1}{\frac{0.931 h}{W} + 0.736} ] \qquad Equation ( 8 )$$

In Equation (8), “εsub” denotes a dielectric constant of the dielectric mounted on the first substrate 61 and the second substrate 71, “h” denotes a thickness of the dielectric substrate, that is, a thickness obtained by stacking the first substrate 61 and the second substrate 71, and “W” denotes the line width of the metal pattern 72.

As shown by the above Equations (3) to (7), it is possible to form a highly sensitive substrate type dielectric spectroscopy sensor 102 by setting the admittance that maximizes the sensitivity.

As an example, in a case where a microstrip line, which is fabricated in a pattern having a wiring thickness of 40 μm, is used as an impedance conversion layer on a PCB having a substrate thickness of 200 μm and a substrate dielectric constant of 3.55, the characteristic impedance can be converted from approximately 50Ω to 75Ω by setting the line width from 400 μm to 150 μm.

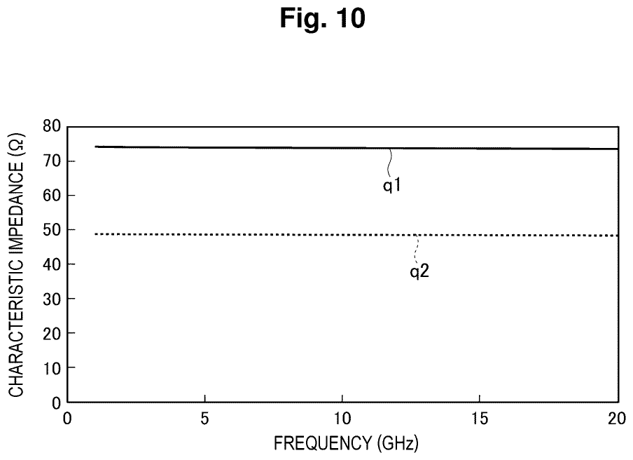

FIG. 10 is a graph showing a relationship between the frequency and the characteristic impedance, and a graph q1 shows the characteristic impedance at the end 72b of the metal pattern 72, and a graph q2 shows the characteristic impedance at the end 72a of the metal pattern 72. As understood from the graphs q1 and q2, the characteristic impedance at the end 72a is approximately 50Ω, and the characteristic impedance at the end 72b is approximately 75Ω, regardless of a change in frequency.

By changing the line width of the metal pattern 72, it is possible to match the characteristic impedance with the connection portion between the transmission line 14 and the dielectric spectroscopy system 20, thereby reducing the reflection loss. A calculation equation for the characteristic impedance of the transmission line other than the above may be used, or conversion efficiency of the characteristic impedance may be calculated by using an electromagnetic field simulator or the like.

Also in the dielectric spectroscopy sensor 102 according to the third embodiment, the one end (first end) of the transmission line 14 has the first characteristic impedance, and the other end (second end) thereof has the second characteristic impedance, as in the above first and second embodiments. This makes it possible to match the characteristic impedance with the dielectric spectroscopy system 20. Therefore, it is possible to reduce the reflection loss at the connection portion. Further, the characteristic impedance on the measurement surface 13 can be arbitrarily set, thereby improving the sensitivity of the dielectric spectroscopy sensor 100.

The present invention is not limited to the above embodiments, and various modifications can be made within the scope of the gist of the present invention.

### REFERENCE SIGNS LIST

11 Connection line
11a High-frequency connector
12, 12a Impedance converter
13 Measurement surface
14 Transmission line
14a High-frequency connector
20 Dielectric spectroscopy system
21, 31, 41 Outer conductor
22, 32, 42 Dielectric
23, 33, 43 Inner conductor
61 First substrate
71 Second substrate
72, 72A Metal pattern (first conductor)
73 Metal pattern (second conductor)
100, 101, 102 Dielectric spectroscopy sensor
M Measurement target object

1. A dielectric spectroscopy sensor to be connected to a dielectric spectroscopy system having a first characteristic impedance, the dielectric spectroscopy sensor comprising:
a transmission line whose first end has the first characteristic impedance and second end has a second characteristic impedance different from the first characteristic impedance, wherein
the first end is connected to the dielectric spectroscopy system, and the second end serves as a measurement surface for measuring a dielectric constant of a measurement target object.

2. The dielectric spectroscopy sensor according to claim 1, wherein:
the transmission line includes a connection line and an impedance converter;
the connection line has the first characteristic impedance as a characteristic impedance, has one end as the first end, and has the other end connected to the impedance converter; and
the impedance converter has one end having the first characteristic impedance and connected to the other end of the connection line and has the other end having the second characteristic impedance and serving as the second end.

3. The dielectric spectroscopy sensor according to claim 2, wherein:
the impedance converter has a coaxial cable structure including an inner conductor and an outer conductor arranged outside the inner conductor via a dielectric; and
the one end of the impedance converter has the first characteristic impedance, and the second end has the second characteristic impedance by monotonically increasing or monotonically decreasing a cross-sectional area of the inner conductor from an end connected to the connection line toward the second end.

4. The dielectric spectroscopy sensor according to claim 2, wherein:
the impedance converter has a coaxial cable structure including an inner conductor and an outer conductor arranged outside the inner conductor via a dielectric; and
the one end of the impedance converter has the first characteristic impedance, and the second end has the second characteristic impedance by changing stepwise a cross-sectional area of the inner conductor from an end connected to the connection line toward the second end.

5. The dielectric spectroscopy sensor according to claim 1, wherein:
the transmission line includes a substrate, a first conductor formed from one end to the other end on a surface of the substrate, and a second conductor insulated from the first conductor; and
a characteristic impedance at the one end of the first conductor is the first characteristic impedance, and a characteristic impedance at the other end is the second characteristic impedance.

6. The dielectric spectroscopy sensor according to claim 5, wherein
the one end of the first conductor has the first characteristic impedance, and the other end of the first conductor has the second characteristic impedance by monotonically increasing or monotonically decreasing a line width of the first conductor from the one end to the other end on the surface of the substrate.

7. The dielectric spectroscopy sensor according to claim 5, wherein
the one end of the first conductor has the first characteristic impedance, and the other end of the first conductor has the second characteristic impedance by changing stepwise the line width of the first conductor from the one end to the other end of the substrate.
